(19) United States
(12) Patent Application Publication
(10) Pub. No.: US 2021/0346244 A1
(43) Pub. Date: Nov. 11, 2021

(54) Thematically Coordinated Pacifier and Pull Away Lanyard

(71) Applicant: Dominique A. Kafando, Erie, PA (US)

(72) Inventor: Dominique A. Kafando, Erie, PA (US)

(21) Appl. No.: 17/316,232

(22) Filed: May 10, 2021

Related U.S. Application Data
(60) Provisional application No. 63/021,795, filed on May 8, 2020.

(51) Int. Cl. A61J 17/00

(52) U.S. Cl. CPC A61J 17/1115; A61J 17/109; A61J 17/001

(57) ABSTRACT

The invention comprises a pacifier holding clip at one end of an around-the-neck lanyard. The upper ends to this lanyard will include easily disconnecting means so as to not risk creating any choking hazards. For aesthetics, this invention provides preferred combinations of pacifiers and decorated lanyards sporting one of many themed lanyard-pacifier pairs.

### CROSS-REFERENCE TO RELATED APPLICATIONS

This application is a perfection of pending U.S. Provisional Application Ser. No. 63/021,795, filed on May 8, 2020, the disclosure of which is fully incorporated herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### (1) Field of the Invention

The present invention pertains to young child and toddler pacifiers and methods for keeping them within reach of the child/user. It also relates to an improved combination of themed pacifiers with lanyards. This invention provides such around-the-neck lanyards with quick disconnect means that will prevent the possibility of accidental choking hazards.

### (2) Description of Related Art including information disclosed under 37 CFR 1.97 and 1.98

This invention addresses an improved combination of pacifier (or binky) and pacifier holder (or lanyard) that is commonly themed and is also suitable for babies/toddlers without creating any choking risks.

There are known pacifier-related inventions and still other means for connecting identification cards to around-the-neck lanyards and the like. But this invention is patentably distinct from all of the following: U.S. Pat. Nos. 4,700,408, 4,765,037, 4,969,894, 4,994,075, 7,020,935, 7,086,121 and 8,603,393; U.S. Design Pat. No. D300,281; along with Published U.S. Application Nos. 20050159779, 20050252939, 20050279136, 20070228228, 20070260280, 20110057005, 20160271020, and 20170238641; and international references: CN102159114 and JP3090831.

### BRIEF SUMMARY OF THE INVENTION

The invention comprises a pacifier holding clip at one end of an around-the-neck lanyard. The upper ends to this lanyard will include easily disconnecting means so as to not risk creating any choking hazards. Many variations of lanyard ends are shown and described herein.

Ideally, for aesthetics, this invention provides preferred combinations of pacifiers and decorated lanyards sporting one of many themed lanyard-pacifier pairs.

### BRIEF DESCRIPTION OF THE DRAWINGS

Other advantages and novel features of the present invention will become apparent in the following detailed description made with reference to the accompanying drawings in which:

FIG. 1 is a top plan view showing one embodiment of this invention with a heart-shaped pacifier/binky attached to a lanyard with a binky clip. The center most portion of FIG. 1 also shows two main binky clip components, i.e., a silicone triangle and the twisty pacifier string (binky wrap) associated therewith;

FIG. 2 is a top plan view showing the binky clip components, i.e., a silicone triangle, and a string element with one means for twisting the latter string element to hold a binky to the lanyard per one embodiment of this invention;

FIG. 3 is a top plan close up view of one embodiment of lanyard connector with its pair of matching, breakaway plastic buckles for connecting together behind the wearer's neck;

FIG. 4 is a top plan close up view of a second embodiment of breakaway plastic buckle ends on an “I Heart-Symbol You” themed lanyard;

FIG. 5 is a top plan close up view of a third embodiment of lanyard closure, this version focusing on at least two, matching snap connector pairs at opposed ends of each lanyard strap;

FIG. 6 is a top plan close up view of a fourth embodiment of lanyard closure, this version replacing one of the lanyard snap pairs with a clip through which the remaining snap pair is threaded before reconnecting to itself;

FIG. 7 is a top plan close up view of a fifth embodiment of lanyard closure, this version being a variation of the fourth (shown in FIG. 6) with the clip being able to slide in a track for about 0.5 to 2 inches of extra leeway before disconnecting;

FIG. 8 is a top plan view of a first coordinated pacifier-lanyard combination, this one displaying a heart-themed lanyard with a pacifier having a heart-shaped center;

FIG. 9 is a top plan view of a second coordinated pair of pacifier-lanyard combinations, this one displaying an alphabet-marked lanyard with a pacifier having an “ABC”—emblazoned center;

FIG. 10 is a top plan view of a third coordinated pair of pacifier-lanyard combinations, this one displaying a vine or leaf-lined lanyard with a pacifier including a flower-shaped center;

FIG. 11 is a top plan view of a fourth coordinated pair of pacifier-lanyard combinations, this one displaying a dog paw marked lanyard with a pacifier including a dog head-shaped center;

FIG. 12 is a top perspective view of a fifth coordinated pair of pacifier-lanyard combinations, this one displaying a plurality of stars and planets lanyard with a pacifier that may include a consistently themed center design;

FIG. 13 is a top perspective view of a sixth coordinated pair of pacifier-lanyard combinations, this one displaying a lanyard with a basket weave or plaid pattern pacifier that may include a consistently themed center design;

FIG. 14 is a perspective view showing one representative connection of lanyard joinder mean about the rear neck of a wearer;

FIG. 15 is a perspective view showing the lanyard from FIG. 14 as seen from the front neck of the wearer;

FIG. 16 is a top view of a representative clip connection means that employs a plurality of matching magnets; and

FIG. 17 is a top view of a representative clip connection means that employs a matching sections of hook and loop (or Velcro®) tape.

### DETAILED DESCRIPTION OF PREFERRED EMBODIMENTS

In the accompanying drawings, common elements to the various embodiments are commonly numbered though in the next hundred series.

With a love for bling and individuality, the inventor has designed a product to help busy parents and their toddlers stay fashionable and comforted. This product will transition into a professional, marketable platform. The invention will help many toddlers and parents on daily basis.

One name for marketing this product is BlingkyTM, a play on the words “bling” and “binky”. The concept is for a lanyard-style binky holder, generally item 10, for toddlers to wear around/about their necks with design options for bling and child-friendly themes. It consists of an around-the-neck lanyard strap 12, having a left side 12L and right side 12R each lanyard side strap having a pair of opposed ends 14, 16 each with complementary or matching connectors 14c and 16c.

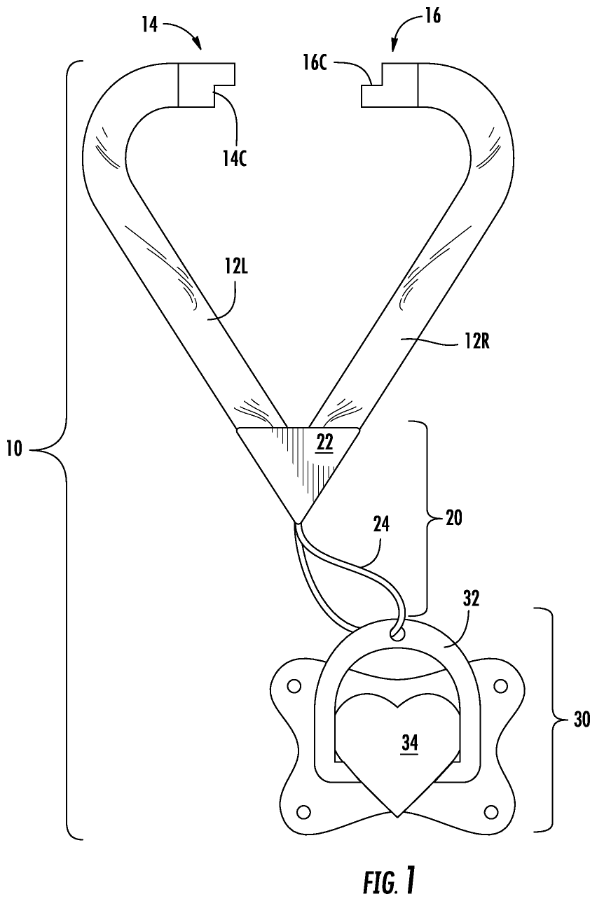

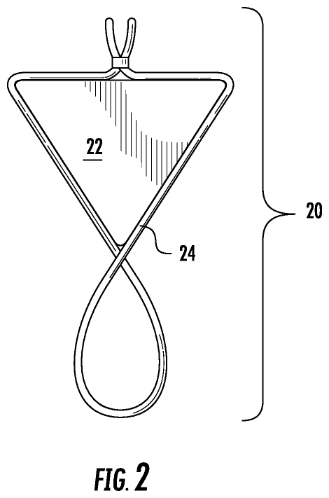

At a central point, in the middle front as seen in FIG. 1, there is shown a lanyard pacifier connector 20 that includes a triangular midpiece 22 (which may or may not be weighted) and a twisty binky wrap cord 24 into which a typical (or “standard” size and shape) pacifier (or binky 30) is situated, the latter typically including a handle end 32 and an outer decorative face 34 from which a baby pacifier component P inwardly protrudes.

A shortcoming of the current way clipped pacifier holders attach to toddler worn clothing is that when the child engages with others or merely walks about a given room/play area, the clip and pacifier will get tugged: (a) out of the toddler's mouth; and (b) often completely away from the clothes to which the clip is/was attached.

The inventor has been working on the design of her Blingky product for some time. While not currently in production, there are mock-ups, technical drawings, and 3-D designs modeling the concept. They will provide a great idea on how a Blingky may look and function once it is ramped up for mass manufacture and sale.

The Blingky 10 will be worn around (or about) the toddler's neck much like a necklace. In one embodiment, there is a two piece buckle component 40 in the upper back of lanyard's style “necklace” holder. That buckle component 40 is designed to help the Blingky be worn (read, stay ON) while also allowing the unit as a whole to be somewhat easily removed, especially when the toddler is laying down in his or her crib/romper, for reducing the risks of accidental choking hazards.

The main body of lanyard strap 12 may be formed from a variety of materials, such as plastic, a cloth or fabric. It can also be made from a natural or synthetic material, or other material for wearing around a toddler's neck. The connecting means can be within the lanyard, mounted to an outer surface of the lanyard, to an end of the lanyard or otherwise attached to the lanyard such that the connecting means does not interfere with a child's comfortable wearing of the lanyard.

At an end of the lanyard's buckle opposite the connecting means, there will be a pacifier connector 20 preferably comprised of a connecting triangular midpiece 22 material (at least temporarily and preferably permanently) attached to twisty binky wrap cord 24. This midpiece and cord combination allows a pacifier/binky 30 to repeatedly connect on and off the lanyard body proper. Pacifier styles may include standard binkies, as well as dust-proof pacifiers that have two side pieces (similar to wings) that can open and close about the central pacifier for keeping it clean-er when the child isn't using it in his or her mouth.

Ideally, the Blingky combinations of this invention will feature fun designs, prints and/or gems. All themes will be present on the necklace straps, with additional decals on the center/back of its pacifier component.

The Blingky's greatest stand-out feature is that it is meant to be worn around the neck of a toddler. Many products in today's market require clipping a pacifier to a shirt, which is not ideal for a small, active child.

This invention lets toddlers “use” their pacifiers on their own terms. When they feel the need have their pacifiers in their mouths, the devices can be made, and kept, easily accessible without having to go find mom or dad. When the toddlers are done using the pacifier components, they can continue to keep the device nearby by safely wearing it like a lanyard about their neck . . . without if having to be put away or kept any sort of unmanageable distance away from the toddler.

This invention helps toddlers (and their parents/caretakers) feel comfortable. Babies and toddlers use pacifiers as a way to sooth themselves. Young children, sometimes as old as pre-school years, use their pacifiers for prolonged periods of time with the average infant weaning age being between 2 and 4ⁱ. Accordingly, their Blingkys should be designed to look fun and fashionable, so they can enjoy wearing them about the house and/or in public. As they enjoy wearing this invention, the toddlers will be able to access their pacifiers whenever needed for immediate comfort.

This invention can be beneficial for the very well being of toddlers. According to the Mayo Clinic, the benefits of pacifier use include: reducing the risk of Sudden Infant Death Syndrome, helping infants fall asleep, soothing them on planes, and offering them a comforting, comfortable distractionⁱⁱ.

With the present invention, parents will be spending less money on binkies. The average child goes through seventy+ pacifiers by the age of 3, or about 6 pacifiers every three months. With the Blingky, the same pacifier can be kept in reach of the toddler all day thus reducing the number of lost pacifiers and need for multiple replacements.

This invention exhibits a decreased choking hazard. The Blingky's design, with its lanyard-style and buckle, is meant to be easily taken on and off, yet relatively secured without any discomfort to the child.

Easily washable/replaceable components. Experts recommend washing a child's pacifier at least once a day—to decrease germs and bacteria. With the Blingky, the pacifier is easily detachable, and perfect for daily cleanings^{iv}. The pacifier of this invention attaches to its lanyard with a clip, so it can be very easily removed for washing between wears. Or, when worn out, the pacifier component can be simply removed and replaced altogether.

The cost of materials used and the selection of actual materials will depend on: (i) the quantity manufactured; and (ii) the buyers/licensees of the Blingky. An appropriate retail price will then be set, based on these materials, manufacturing, and advertising costs. In any event, the selected materials will need to be safe for children to wear for prolonged periods of time.

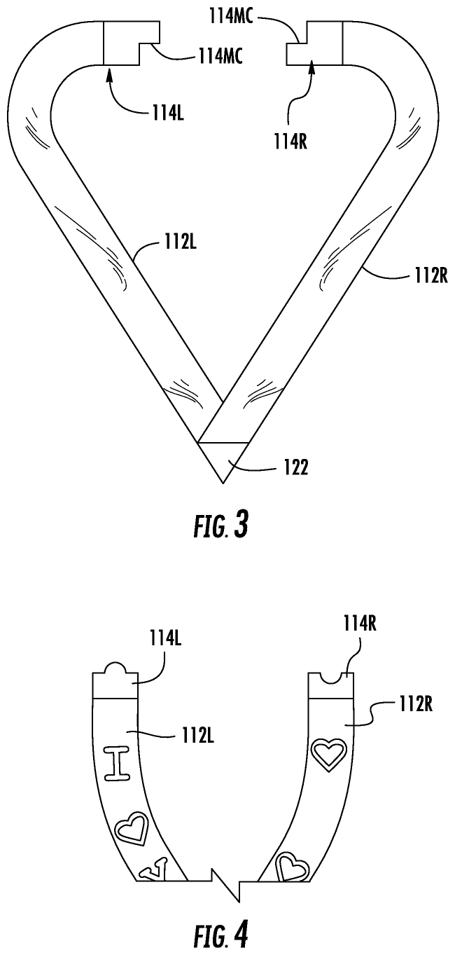

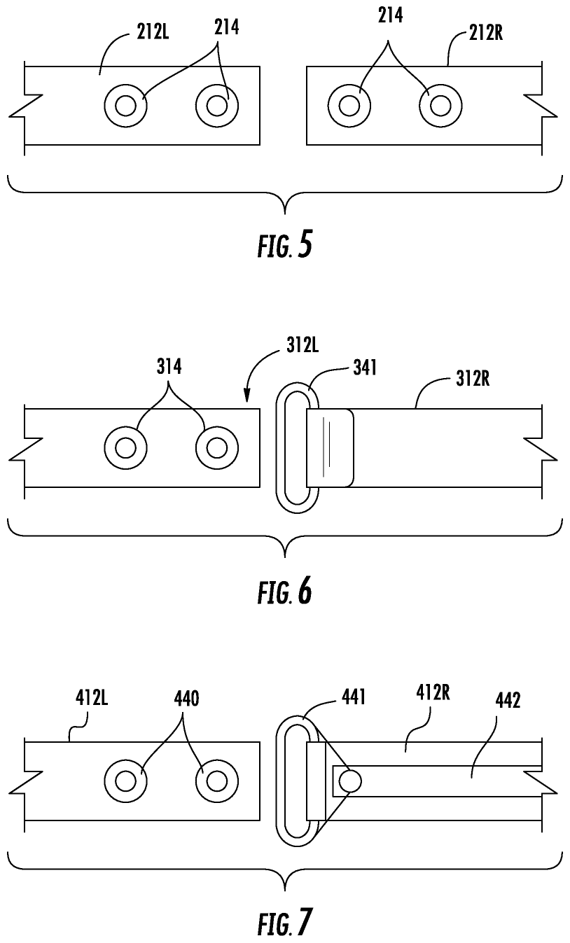

Referring to FIGS. 3-7, there are shown several types of alternate lanyard connector\means. FIG. 3 shows a pair of L-shaped plastic connectors 40L and R. In FIG. 4, semicircular connectors 114L and R are found at opposed lanyard strap ends with their matching connectors 114MC.

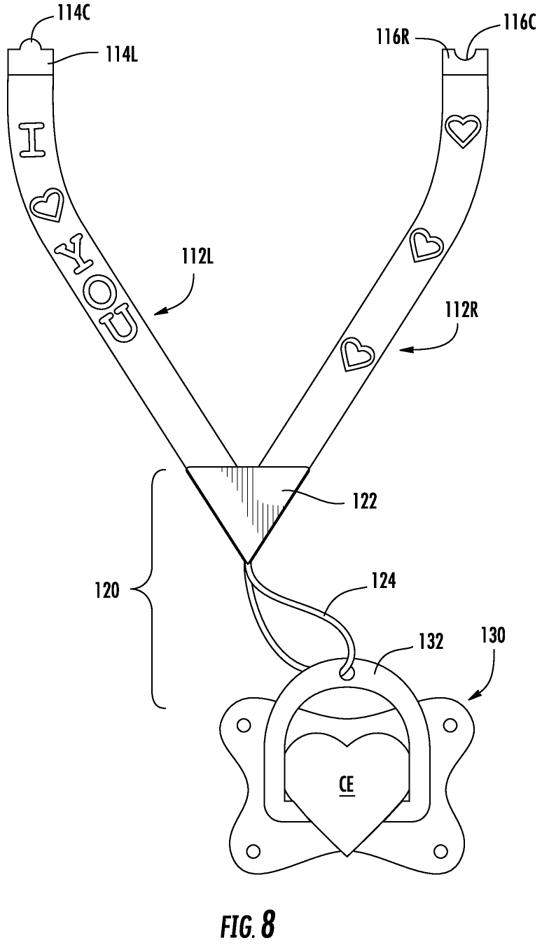

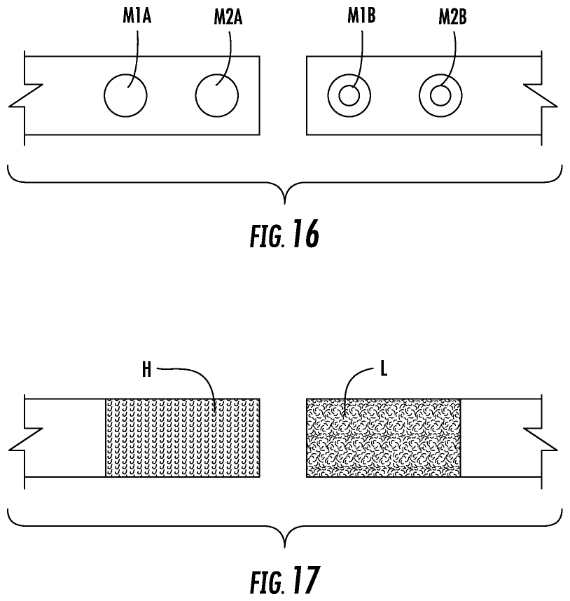

The two lanyard strap ends in FIG. 5 are fitted with a plurality of push-together snaps 214. FIG. 6 is a first variation wherein the snap strip 312L first gets fed through an oval buckle 341 before reconnecting to itself. In FIG. 7, one more advanced version shows adding a buckle 441 for accommodating its snap strap 440—but this version is able to slidably move in track 442 a short distance in one lateral direction. It would allow that lanyard connect to move about ½ inch to 2 total inches, for providing still greater wearer flexibility before fully disconnecting. Still other versions may include one or more pairs of matching magnets (items M1A and M1B, M2A and M2B in FIG. 16, ball-in-socket joinders (not shown), and sections of Velcro® (i.e., hook and loop) strips or tape sections that either connect to one another (like the H ends and L ends of FIG.17 . . . or through a clip and then to itself (not shown but similar to that of FIG. 6).

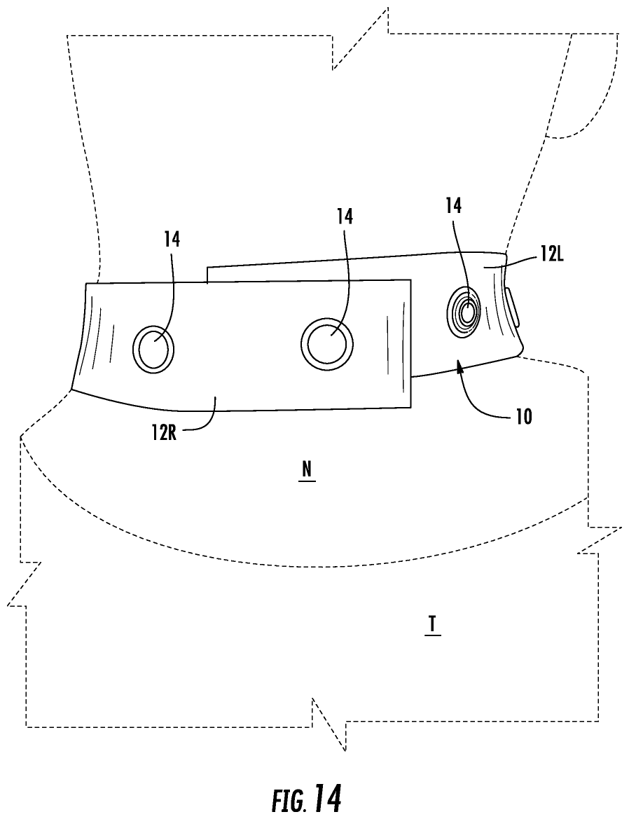

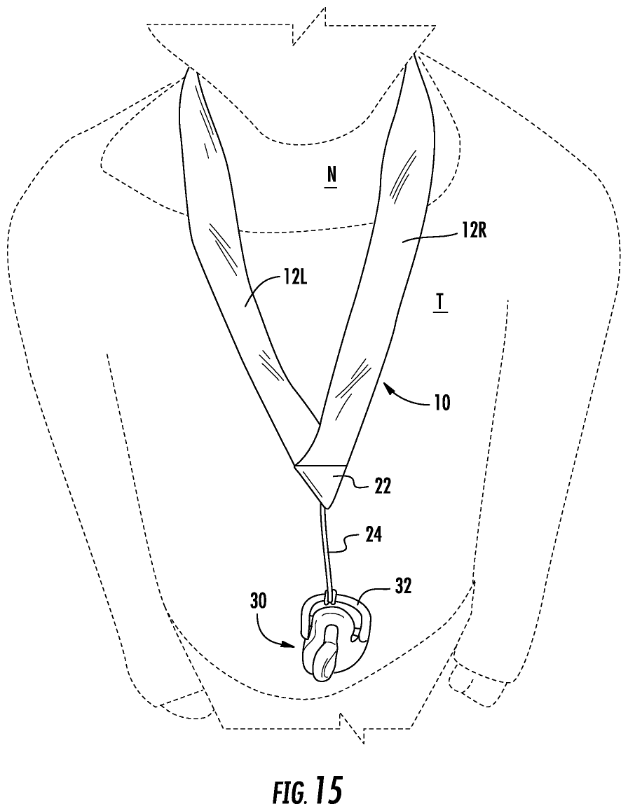

In use, the lanyard is worn around the neck of a toddler to allow him or her to retain their pacifier “nearby” so that should it fall out of the toddler's mouth, it can be easily grabbed and reinserted into his or her mouth. See generally, the views of an installed Blingky 10 about the neck N of a toddler T in FIGS. 14 and 15.

The pacifier connecting means allows an adult to easily remove the pacifier from the Blingky, in order to wash and reinsert it or remove it and replace with another pacifier, to be sold separately from the whole unit. The connecting means are especially intended to permit their relative separation from each other should the lanyard be placed in tension, intentionally or accidentally. In such an event, the lanyard will open up and separate apart so as to not injure (or accidentally choke) the toddler wearing the same.

### Marketing

The inventor envisions helping parents, guardians, and toddlers alike feel the fun and comfort of an easily accessible Blingky. Parents, pre-schools, daycares, and children's retail stores would be the logical starting consumer groups. As of 2016, the U.S. baby product industry grossed over 44 billion dollars, with sales of pacifiers/“teethers” making up over 21 million dollarsv. This means a rather large potential market in which to sell the Blingky. Specialty stores for families of toddlers, like Gymboree, are potential retailers for the Blingky, as well as general supply stores like Target and Walmart. The internet provides yet another exploitable platform for sales and advertising, with online retailers such as Amazon, and the popular uprising of “Mommy Bloggers to provide more retail sources.

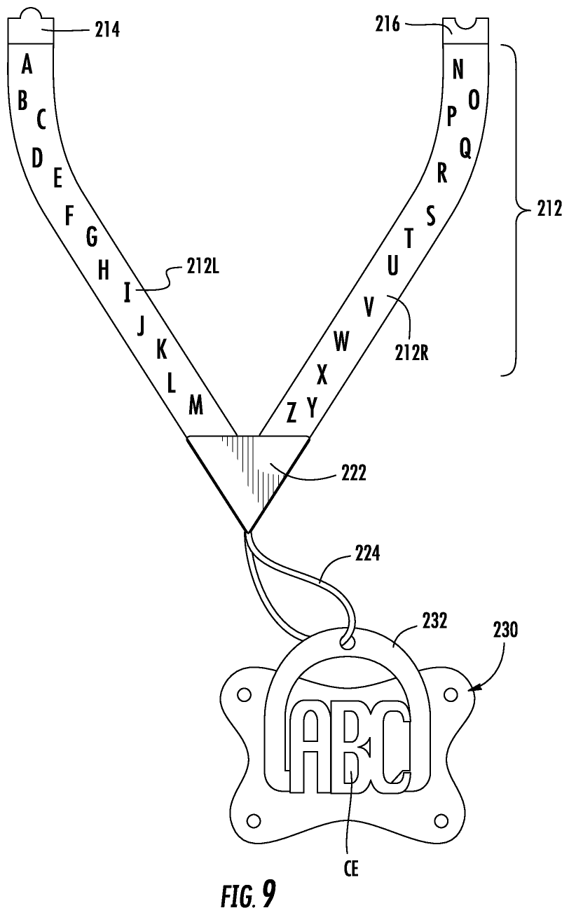

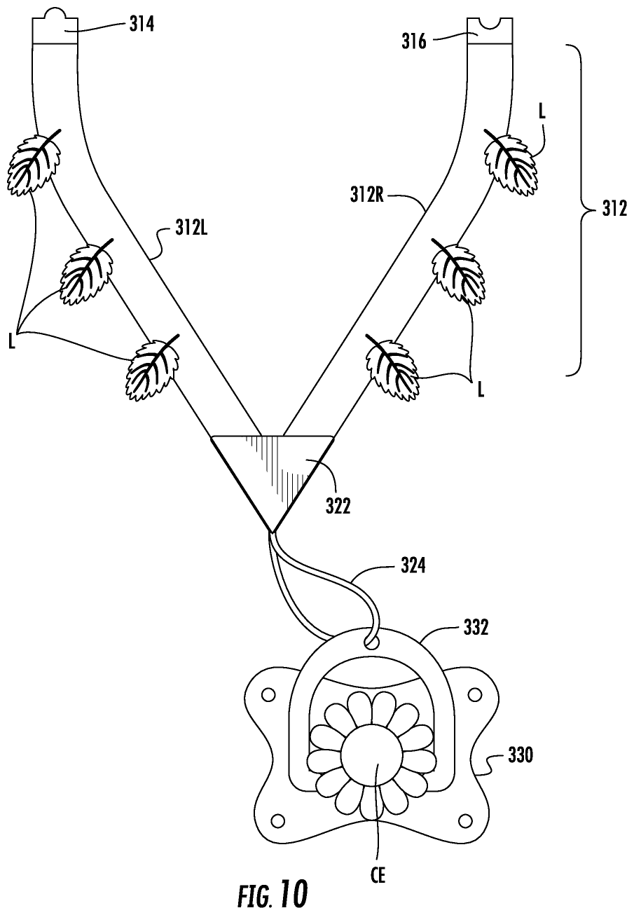

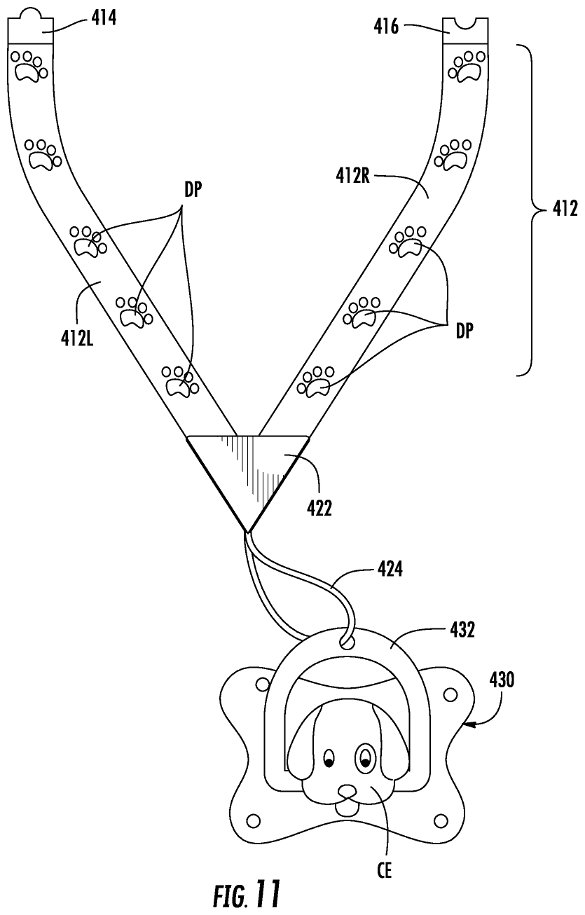

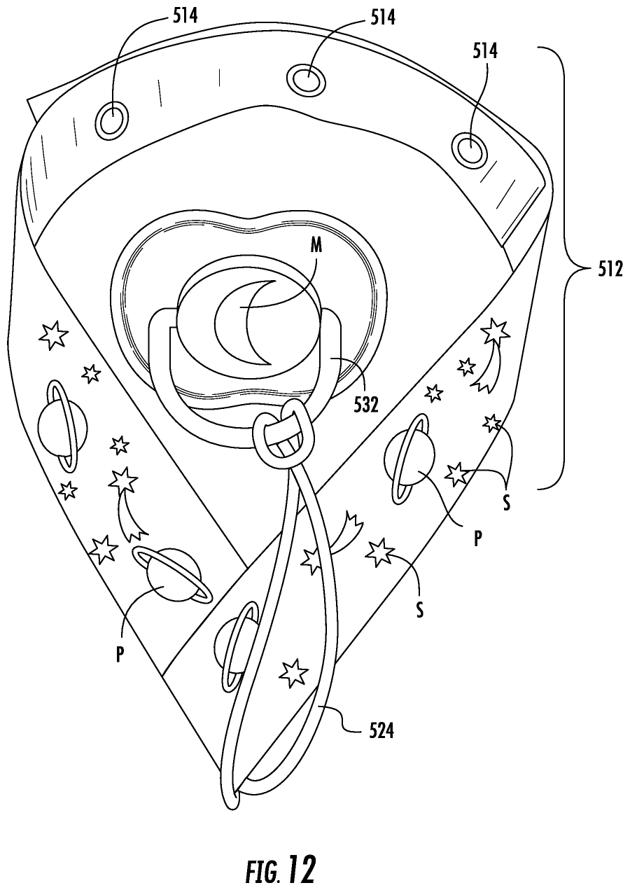

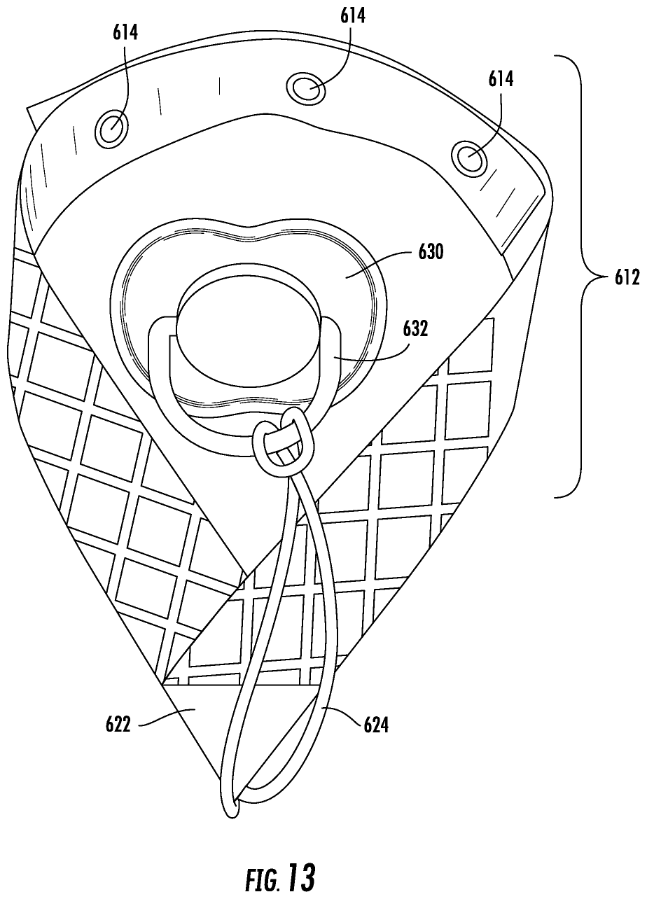

In the other accompanying FIGS, there is shown combinations of lanyards-pacifiers that are intentionally themed in a coordinated manner. For instance, FIG. 8 shows a first alternate lanyard body 112 with a plurality of hearts and “I HEART (symbol) YOU” messages used in conjunction with a pacifier/binky 130 displaying a heart-shaped center element CE. FIG. 9 shows a second alternate lanyard body 212 (with a plurality of alphabet-letters used in conjunction with a pacifier/binky 230 displaying a central shaped element CE bearing the letters ABC. FIG. 10 shows a third alternate lanyard body 312 (with a plurality of leaves L used in conjunction with a pacifier/binky 330 displaying a flower-shaped central element CE. FIG. 11 shows a fourth alternate lanyard body 412 (with a plurality of dog paw prints DP used in conjunction with a pacifier/binky 430 displaying a dog head-shaped central element CE. FIG. 12 shows a fifth alternate lanyard body 512 with a plurality of stars S and planets P depicted. It could be combined with a pacifier/binky 530 displaying one of several space-themed elements like the moon M. Lastly, FIG. 13 shows a sixth lanyard body 612 with a basket weave (or “plaid”) appearance for use with a similarly themed pacifier/binky 630.

### SEQUENCE LISTING

Not applicable.

ⁱ Team, The BabyCenter Editorial. “When Should My Baby Stop Using a Pacifier?” BabyCenter, 16 Mar. 2016, www.babycenter.com/404_when-should-my-baby-stop-using-a-pacifier_1368496.bc.
ⁱⁱ “Pacifier Do's and Don'ts.” Mayo Clinic, Mayo Foundation for Medical Education and Research, 22 Jul. 2017, www.mayoclinic.org/healthy-lifestyle/infant-and-toddler-health/in-depth/pacifiers/art-20048140.
ⁱⁱⁱ “How Many Pacifiers Do You Need?” Pacif-i™, 2017, www.pacif-i.io/blogs/news/how-many-pacifiers-do-you-need.
ᵢᵥ Reviewed by the BabyCenter Medical Advisory BoardLast updated: September 2016. “Pacifiers and Your Toddler.” BabyCenter, 17 Apr. 2015, www.babycenter.com/0_pacifiers-and-your-toddler_12254.bc?page=2.
^{v} Statistic Brain. “Baby Care Product Industry Statistics.” Statistic Brain, 8 Aug. 2016, www.statisticbrain.com/baby-care-product-industry-statistic/.

Having described the best modes currently known for practicing these lanyard and pacifier combinations, it is to be understood that the scope of this invention may be further described by the attached claims.

What is claimed is:

1. A toddler pacifier and lanyard combination comprising:
(a) a main lanyard body having two straps for wrapping about a neck of the toddler and temporarily, loosely connecting to each other at opposed strap ends so as to readily, easily disconnect with a nominal amount of tension placed on one or both strap ends;
(b) a stand alone pacifier; and
(c) a pacifier connector at or near a lower midpoint of the main lanyard body, said pacifier connector including a triangular connection piece and a section of twisty cord for wrapping about the stand alone pacifier.

2. The toddler pacifier and lanyard combination of claim 1, which is thematically coordinated.

3. The toddler pacifier and lanyard combination of claim 2 wherein the stand alone pacifier and the two straps of the main lanyard body include a plurality of heart shapes.

4. The toddler pacifier and lanyard combination of claim 2 wherein the stand alone pacifier and the two straps of the main lanyard body include a plurality of alphabet letters.

5. The toddler pacifier and lanyard combination of claim 2 wherein the stand alone pacifier and the two straps of the main lanyard body include a plurality of dog-themed images.

6. The toddler pacifier and lanyard combination of claim 5 wherein the plurality of dog-themed images include dog paw marks and dog-shaped heads.

7. The toddler pacifier and lanyard combination of claim 2 wherein the stand alone pacifier and the two straps of the main lanyard body include a plurality of flower-themed images.

8. The toddler pacifier and lanyard combination of claim 7 wherein the plurality of flower-themed images include at least one of a group consisting of vines, leaves and flowers.

9. The toddler pacifier and lanyard combination of claim 1 wherein the loose connection at opposed strap ends includes a pair of matching plastic snap connectors.

10. The toddler pacifier and lanyard combination of claim 1 wherein the loose connection at opposed strap ends includes two or more strips of spaced apart metal snaps.

11. The toddler pacifier and lanyard combination of claim 10 wherein the lanyard connecting means further includes a clip through which a section of one of the two strips of spaced apart metal snaps is threaded before reconnecting to itself.

12. The toddler pacifier and lanyard combination of claim 11 wherein the clip is attached to a track for allowing lateral movement therealong.

13. The toddler pacifier and lanyard combination of claim 12 wherein the clip track allows for about ½″ to 2″ of movement therealong.

14. The toddler pacifier and lanyard combination of claim 1 wherein the loose connection at opposed strap ends includes two or more sections of interconnecting magnets.

15. The toddler pacifier and lanyard combination of claim 1 wherein the loose connection at opposed strap ends includes two or more sections of matching hook-and-loop tape.
